(19) United States
(12) Patent Application Publication
(10) Pub. No.: US 2016/0097670 A1
(43) Pub. Date: Apr. 7, 2016

(54) RESOLUTION MODE SWITCHING FOR PULSED RADAR

(71) Applicant: Honeywell International Inc., Morristown, NJ (US)

(72) Inventors: MICHAEL KON YEW HUGHES, VANCOUVER (CA); FRANK MARTIN HARAN, NORTH VANCOUVER (CA)

(21) Appl. No.: 14/859,752

(22) Filed: Sep. 21, 2015

Related U.S. Application Data
(60) Provisional application No. 62/058,387, filed on Oct. 1, 2014.

(51) Int. Cl. G01F 23/284

(52) U.S. Cl. CPC G01F 23/284

(57) ABSTRACT

A method of pulsed radar level sensing. First level scanning performed with first transmitted radar pulses launched by a probe into a tank having a first pulse width, wherein the first level scanning is over a first scan distance. First echoes generated responsive to the first pulses are analyzed to determine an approximate level of a material in the tank. Second level scanning with second transmitted radar pulses are launched by the probe into the tank having a second pulse width, with a measurement window<the first scan distance that includes the approximate level. The second pulse width<the first pulse width. Second echoes generated responsive to the second pulses are analyzed to determine a revised higher resolution material level measurement.

### CROSS REFERENCE TO RELATED APPLICATIONS

This application claims the benefit of Provisional Application Ser. No. 62/058,387 entitled “RESOLUTION MODE SWITCHING FOR PULSED RADAR LEVEL SENSING”, filed Oct. 1, 2014, which is herein incorporated by reference in its entirety.

### FIELD

Disclosed embodiments relate to time domain reflectometry for pulsed radar level sensing.

### BACKGROUND

Industrial plants having containers or tanks (“tanks”) generally need to regularly measure the level of liquid(s) or other materials therein such as powders. There are several types of systems and techniques used for level measurement, which generally use time domain reflectometry (TDR) that relies on analyzing echoes using time-of-flight to determine range.

Radar can either be contact radar or non-contact radar (NCR), and either pulsed or continuous wave radar. Frequency modulated continuous wave (FMCW is usually used as NCR Pulsed radar level gauge systems generally used time expansion techniques to resolve the time-of-flight (TOF).

GWR is a particular contact pulsed radar method used to measure the level of liquids or solids in a tank. GWR works by generating a stream of pulses of electromagnetic energy and propagating the pulses down a transmission line formed into a level sensing probe (or waveguide). The probe is generally placed vertically in a tank or other container and the electromagnetic pulse is launched downward from the top of the probe. The probe is open to both the air and the material(s) to be sensed in such a way that the electromagnetic fields of the propagating pulse penetrate the air until they reach the level of the material. At that point, the electromagnetic fields see the higher dielectric constant of the material. This higher dielectric constant causes a reduction in the impedance of the transmission line, resulting in a pulse echo being reflected back to the top of the probe. The pulse travels through the air dielectric portion of the probe at a known velocity. This allows the material level(s) on the probe to be determined by measuring the round trip travel time of the pulse from the top of the probe to the level and the echo back to the top of the probe.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize conventional pulsed radar level gauge (PRG) based-systems for determining material level(s) in storage tanks (tanks) are sometimes constrained by supplied power limitations to operate at low power (e.g., <10 mW), such as when powered by a two wire connection (e.g., 4 to 20 mA at voltages as low as 10.5 V), where the communications electronics (e.g., transceiver) of the PRG can take most of the power supplied. Because of the power limitations for instantaneous power supplied to the circuitry of the PRG, energy is accumulated/stored in-between scanning/sampling pulses, typically stored in a power accumulator such as capacitor bank of a power accumulator board. A problem arises due to the need for the PRG to render a first (initial) level measurement as soon as possible (e.g., <60 seconds) as there may be only enough power stored available to sample about 5 m to 20 m of the length of the probe (which may be about 75 m long, for example, for guided wave radar (GWR)) at a time (each sampling or scan), so that one may not be able to meet the startup requirement of a prompt initial level measurement, particularly when the needed level resolution is less than or equal to (≦) about 1 mm.

Additionally, when facing relatively challenging process conditions, such as when the product material comprises a foam or an emulsion, rapidly changing process levels, thin interfaces, and/or moving obstacles in the tank, the current level information can be lost. In such cases, it is may be necessary for the PRG to again find the level as soon as possible. This results in a need to essentially again initialize and complete a new level measurement.

One disclosed embodiment is a method of pulsed radar level sensing including resolution mode switching. First (initial) level scanning is performed with first transmitted radar pulses launched into a tank by a probe having a first pulse width. The first level scanning can scan a first scan distance that is across at least a majority (>50%) of a length of the probe (probe length). The first level scanning is a relatively low-resolution mode resulting from using a relatively wide pulse width compared to the relatively high-resolution mode resulting from using a relatively narrow pulse width used for at least the second level scanning which follows the first level scanning.

First echoes generated responsive to the first pulses are received and then analyzed to determine an approximate level of the product material in the tank. Second level scanning is performed with second transmitted radar pulses launched into the tank having a second pulse width, with a measurement window<the first scan distance that includes the approximate level. The second pulse width<the first pulse width. Second echoes generated responsive to the second pulses are analyzed to determine a revised higher resolution level measurement for the material. Although generally described herein using 2 resolution levels of scanning, more than 2 resolution levels of scanning may also be used with successively narrower pulse widths with resulting higher range resolution levels.

### BRIEF DESCRIPTION OF THE DRAWINGS

FIG. 1 is a flow chart that shows steps in an example method of pulsed radar level finding using resolution mode switching, according to an example embodiment.

FIG. 2 depicts an example GWR system including a disclosed pulsed radar level gauge circuit which implements a resolution mode switching algorithm stored in the firmware of a memory associated with a processor, according to an example embodiment.

FIG. 3A is a plot of pulse width (in psec) vs. control voltage, according to an example embodiment.

FIG. 3B is a plot of normalized voltage vs. time (in ns) showing different pulse widths resulting from use of different control voltages, according to an example embodiment.

FIG. 4A shows an example echo curves resulting from a first pulse width, and FIG. 4B shows an example echo curves resulting from a second smaller pulse width, according to example embodiments.

FIG. 5A depicts a first probe relatively low resolution pass (wide pulse width) that scans across essentially the entire probe length that upon echo signal analysis yields at least one approximate level, and FIG. 5B depicts a second relatively high resolution pass (narrower pulse width) that scans across a window including the approximate level(s) that upon echo signal analysis yields a revised level, according to example embodiments.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

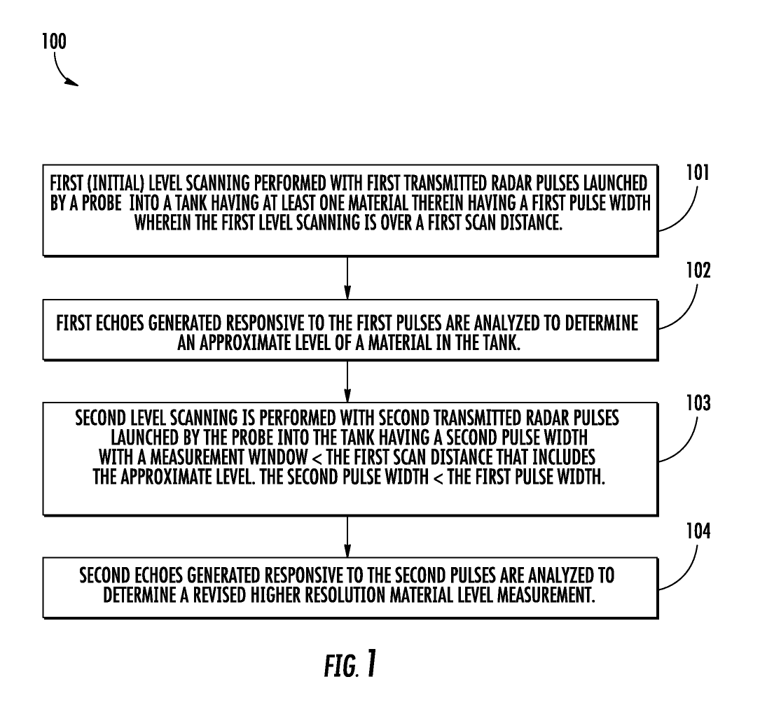

FIG. 1 is a flow chart that shows steps in an example method 100 of pulsed radar level sensing using resolution mode switching, according to an example embodiment. Disclosed embodiments involve pulsed radar level sensing for material(s) in a tank using two or more different resolution mode (RMs) scans (or sweeps) that determine the material level in a tank from echo curves. The first scan is performed using initial low resolution transmission settings (relatively wide pulse width), then at least a second level scan is performed using a higher resolution transmission settings (relatively narrow pulse width). As noted above, although disclosed level finding is generally described for GWR applications, disclosed embodiments can also be applied to non-contact radar.

Step 101 comprises first (initial) level scanning performed with first transmitted radar pulses launched by a probe (or waveguide) into a tank having at least one material therein using a first pulse width. At this point in time there is generally no information as to what the current level in the tank is. The first level scanning scans a first scan distance that is generally across at least a majority (>50%) of a length of the probe (probe length), that can be the entire probe length. The first level scanning is a relatively low-resolution mode by using a relatively wide pulse width compared to the second level scanning which follows the first level scanning that implements a higher resolution mode by using a relatively narrow pulse width.

In step 102, first echoes generated responsive to the first pulses are analyzed to determine an approximate level(s) of a material in the tank. Step 103 comprises second level scanning performed with second transmitted radar pulses launched into the tank having a second pulse width, with a measurement window<the first scan distance that includes the approximate level. The second pulse width<the first pulse width. In step 104, second echoes generated responsive to the second pulses are analyzed to determine a revised material level measurement.

In one embodiment the second pulse width is less than or equal to (<) ½ the first pulse width, with the corresponding resolution of the second level scanning being two (2) times the resolution of the first level scanning. In one particular embodiment the first pulse width can be >1000 ps and the second pulse width is <500 ps. In some embodiment the probe length is at least 20 m, the probe is in contact with the material(s), and the method comprises guided wave radar (GWR). The processor can comprise a microprocessor, microcontroller, digital signal processor (DSP), field programmable gate array (FPGA), application specific integrated circuit (ASIC), or discrete logic devices.

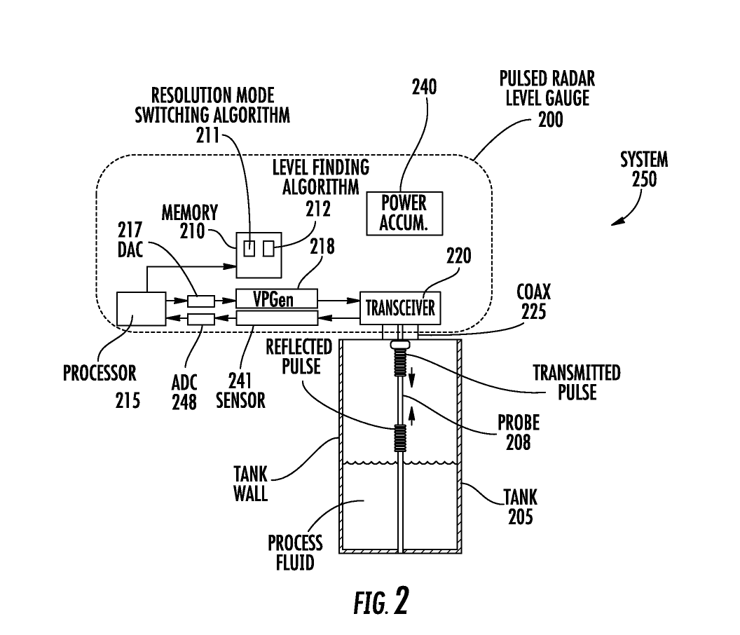

FIG. 2 depicts an example GWR system 250 including a disclosed PRG 200 which implements a resolution mode switching algorithm 211 generally implemented in the firmware of a memory 210 associated with a processor 215, according to an example embodiment. A level finding algorithm 212 is also shown in the firmware of a memory 210. Processor 215 can comprise a DSP or MCU, and a DSP or MCU chip can include the memory 210 on chip, such as on flash memory for storing the respective algorithms.

In the transmit mode the processor 215 provides digital signal levels to a digital to analog converter (DAC) 217 which is connected to an input of a variable pulse width generator (VPGen) block 218 that includes pulse width setting circuitry. Although not shown, the VPGen block 218 can include a first oscillator providing a first clock which can trigger the Tx pulses. The first oscillator circuit triggers the pulse, and the pulse width output by the VPGen block 218 can be independently controlled by a voltage based on the digital signal level that is output by the processor 215.

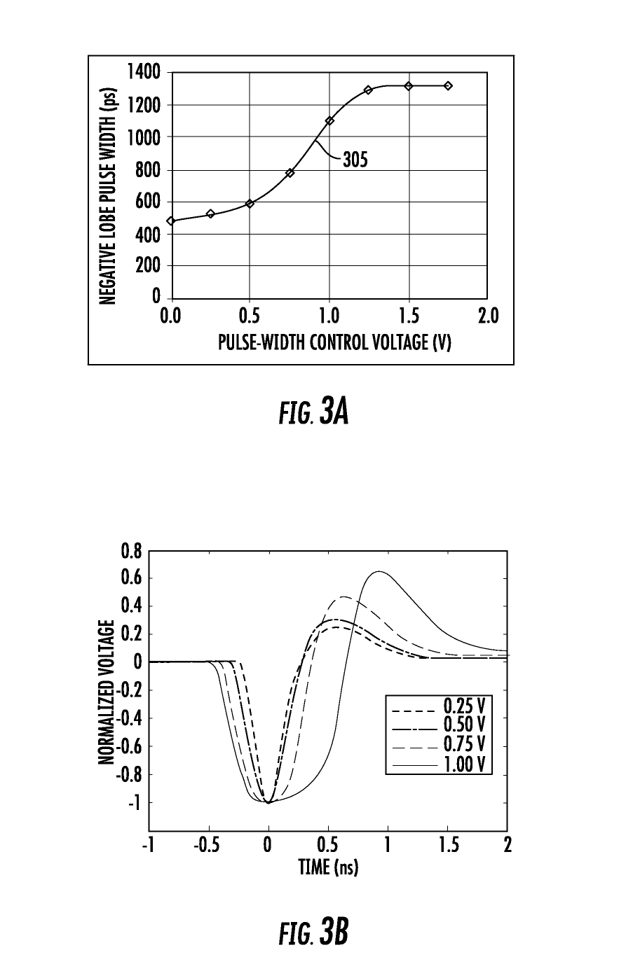

The voltage level applied to the VPGen block 218 can determine the pulse width of the pulses output (see FIG. 3A described below). The pulse widths of the signals output from the VPGen block 218 can have different pulse widths that lead to transmitted signals that penetrate to different depths in the tank 205. The VPGen block 218 provides analog pulse signals to the transmitter of the transceiver 220 for transmission into the tank 205 through the probe 208. The transmitter and the receiver provided by transceiver 220 may be implemented as separate blocks. Accordingly, a “transceiver” as used herein includes both of these arrangements.

The VPGen block 218 can comprise generally comprise any variable pulse-width generator circuit that provides a pulse width less than the total travel time, or the reflected pulse will return while the radar is still transmitting. One arrangement comprises a custom application specific integrated circuit (ASIC) having a delay circuit which has a voltage dependent delay. The VPGen block 218 can also comprise a digitally controlled potentiometer in an oscillator circuit. The second oscillator triggers a receive circuit which is needed for equivalent time sampling (ETS). The second oscillator triggers a replica of the transmitted pulse in the ASIC. This replica is combined with the received level pulse in a microwave mixer. The integrated voltage output of the mixer corresponds to the high-frequency pulse shape, but in a low-frequency form which can be analyzed by the processor 215, where the potentiometer is used to precisely control the frequency difference between the two oscillators. At each clock cycle the mixer output is integrated, where the voltage corresponds to a point on the high frequency waveform. Over many clock cycles the complete waveform can be generated but in a low-frequency ‘equivalent time’. It is noted it is also possible if there is enough range on the pulse width to not vary the frequency difference to multiples of the base frequency difference, but to take every second or third pulse instead.

A control voltage corresponding to the desired pulse width output by the VPGen block 218 can be calculated or otherwise determined. For example, one can determine the control voltage using an equation or an empirically determined look-up table, wherein the input parameters include the desired pulse width, and one can calculate the voltage needed to cause the VPGen block 218 to output signals having the desired pulse width. In some embodiments, a model can be used to determine the control voltage corresponding to a desired pulse width. It is noted that pulse width is generally inversely proportional to bandwidth.

The level in the tank can be determined in any suitable manner, such as by using TDR and time-of-flight (TOF) calculations. The processor 215 functioning as an analyzer can through the VPGen block 218 control the transmitter of the transceiver 220 to output a series of signals that are used to obtain level measurements during this time. For example, a series of signals can include thousands or tens of thousands of pulses. In particular embodiments, the GWR can transmit one pulse per microsecond. During this process, the processor 215 functioning as an analyzer determines the pulse width for each signal in a series of signals transmitted from the PRG 200 in order to perform object discrimination. The analyzer can use an ETS technique or other technique in which each pulse corresponds to a certain range of measurements.

As a specific example, the PRG 200 can accomplish ETS by having a pair of pulses, each being generated by a separate oscillator circuit. The first pulse triggers the pulse generation. The second pulse determines the sample-timing of the pulse reflection. For example, if the second pulse follows by say a nanosecond (i.e., 10⁻⁹ seconds) after the first pulse then the sampling distance is the speed of light c/2*1×10⁻⁹ seconds=15 cm away. Each successive receive pulse has a slightly longer time delay representing an additional distance of, for example, 6 mm, such that the probe 208 is sampled at distances of 15 cm, 15.006 cm, 15.012 cm and so forth with each successive pulse. Other techniques can be used to accomplish ETS without departing from the scope of this disclosure.

In the receive mode, the receiver of the transceiver 220 receives reflected echo signals that are transduced by the sensor 241, where the output signal from the sensor 241 is coupled to an analog-to-digital converter (ADC) 248 which converts analog signals from the sensor 241 into digital signals for the processor 215 which functions as a signal analyzer. Although not shown, a second oscillator providing a second clock is used to help analyze the received pulses as is known in the art and is briefly described above to implement ETS.

PRG 200 is shown including a power accumulation module 240. That is, the PRG 200 consumes relatively large amounts of power for brief periods of a burst mode and accumulates charge (e.g., in capacitors) for the remaining time. The power accumulation module 240 of the PRG circuit 200 is coupled to receive power from an external power source, such as over two wires. The power accumulator module 240 can comprise a battery, or a capacitor bank.

The transceiver 220 is coupled to the probe (or waveguide) 208 via a coaxial connector 225. Coaxial connector 225 is generally installed on a feed-through (not shown). Also shown is transceiver 220 and coaxial connector 225 that is on the top of the tank 205. A flange having a feed-through therethrough (not shown) may also be present. As noted above, although generally described for GWR applications, disclosed level finding can also be applied to ultrasound and non-contacting radar.

The processor 215 may be connected to external communication lines for analog and/or digital communication via a suitable interface. Moreover, although not shown in FIG. 2, the PRG 200 is typically connectable to an external power source, or it may be powered through external communication lines. Alternatively, the PRG 200 may be powered locally, and may be configured to communicate wirelessly.

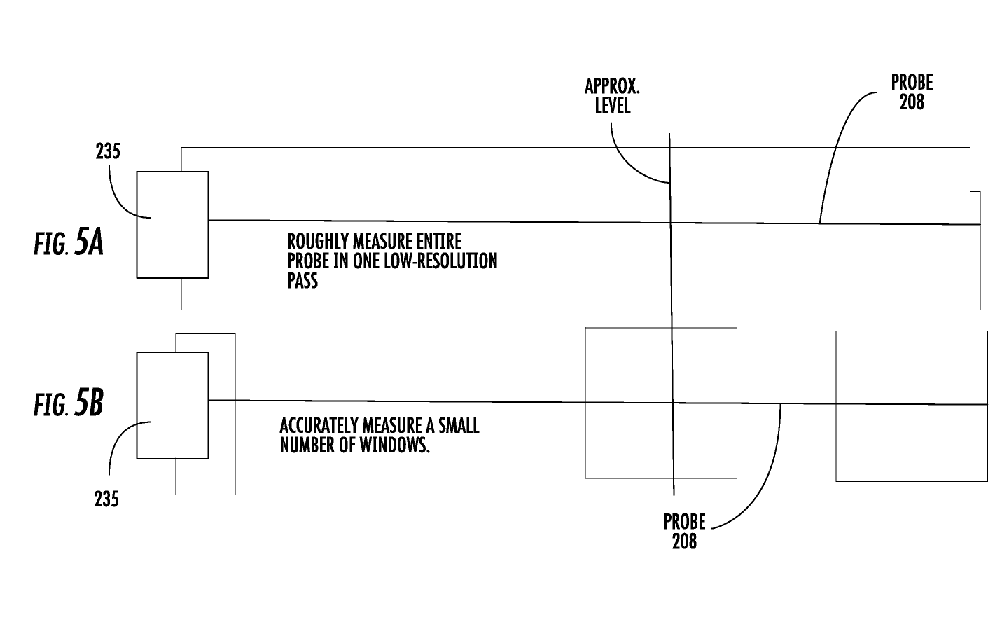

Regarding operation of the PRG 200, for example, assume one cannot determine the level for entire probe 208 at once due to supplied (or stored) power limitations, but would like to find the level(s) as quickly as possible on a 75 m long probe, such as the PRG 200 being limited to two 5,000 sample measurement windows. An approximate level can be found quickly in the low-resolution (e.g., 8 mm) measurement mode (2×5,000×8 mm=80 m>length), where an initial approximate level may be found (see FIG. 5A described below). After finding the initial approximate level, a more precise measurement with a reduced pulse width leading to a higher resolution can then be performed near the approximately found level (see FIG. 5B described below).

### EXAMPLES

Disclosed embodiments are further illustrated by the following specific Examples, which should not be construed as limiting the scope or content of this Disclosure in any way.

FIG. 3A illustrates an example relationship between pulse width and control voltage (V) in a PRG, such as a GWR. In particular, FIG. 3A is a graphical representation of the negative lobe of the pulse versus control voltage (V), which is denoted by a line 305. The line 305 can be used to define a model that is used to identify a control voltage associated with a desired pulse width.

FIG. 3B illustrates example waveforms representing signals used to measure the level of a material in a tank. As shown in FIG. 3B, the transmitter transmits signals via the probe 208 into the tank 205 at different pulse widths associated with control voltages of 0.25 V, 0.5 V, 0.75 V, and 1.0 V, respectively. As shown here, the waveforms of the transmitted signals vary depending on the pulse widths.

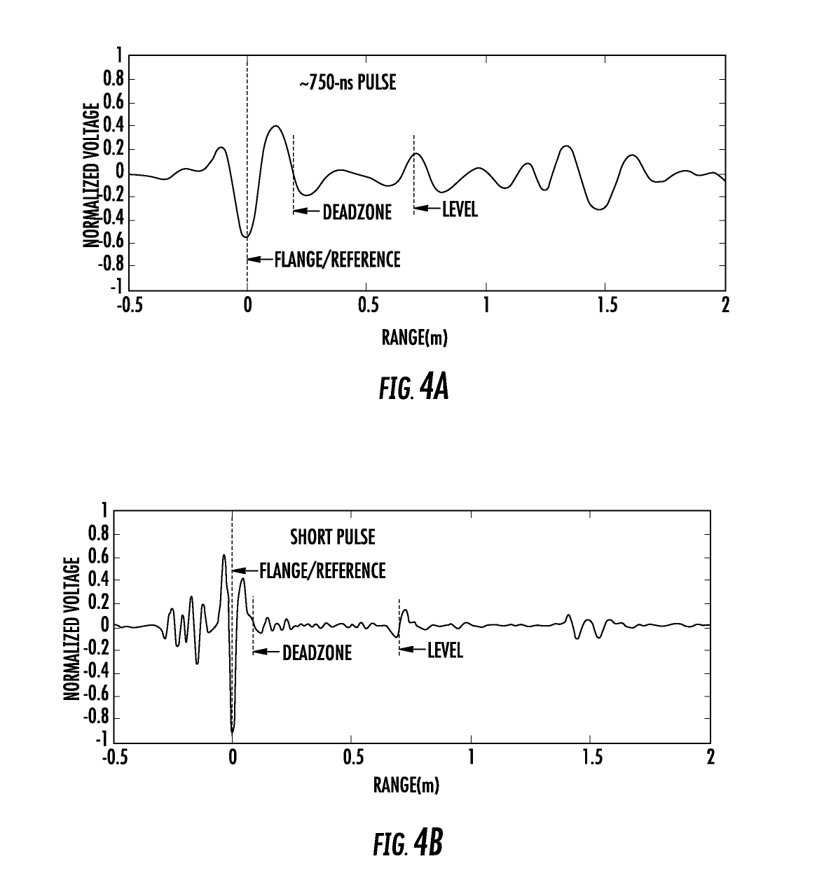

FIG. 4A shows an example echo curves resulting from a first pulse width (750 nsec), and FIG. 4B shows an example echo curves resulting from a second smaller pulse width (250 nsec, shown as a “short pulse”), for the same materials contents in the tank, according to example embodiments. This shows the voltage as a function of time which is transmitted along the probe. It is a bipolar pulse and one can characterize the pulse width as being the full width at half minimum of the negative portion of the pulse. Between FIGS. 4A and 4B it can be seen that one can use a control voltage to vary the pulse width over a wide range.

As described above, for limited power availability PRGs, it may not be possible to measure the entire probe length at once, but users may need to find the material level(s) as quickly as possible, such as when using a 75 m long probe. FIG. 5A depicts a first probe relatively low resolution scan (wide pulse width and large range resolution) that scans across essentially the entire length of the probe 208 coupled to a tank by a feedthrough 235 that upon analysis yields at least one approximate level. The first scan thus roughly measures an entire probe length in one low-resolution “pass” to find an approximate level.

After the approximate level is found, the method moves to high-resolution mode around the approximate level(s) to provide more accurate (higher resolution) measurements. FIG. 5B depicts a second relatively high resolution pass (narrower pulse width and smaller range resolution) that scans across windows including a window shown including the approximate level that upon analysis yields a revised level measurement, according to an example embodiment.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure, such as applying disclosed embodiments to ultrasound level sensing systems. In addition, while a particular feature may have been disclosed with respect to only one of several implementations, such feature may be combined with one or more other features of the other implementations as may be desired and advantageous for any given or particular application.

1. A method of pulsed radar level sensing, comprising:
first level scanning performed with first transmitted radar pulses launched by a probe into a tank having at least one material therein, wherein said first transmitted radar pulses have a first pulse width, wherein said first level scanning is over a first scan distance;
analyzing first echoes generated responsive to said first transmitted radar pulses to determine at least one approximate level for said material in said tank;
second level scanning performed with second transmitted radar pulses launched by said probe into said tank with a first measurement window including said approximate level that is less than (<) said first scan distance, wherein said second transmitted radar pulses have a second pulse width that is less than (<) said first pulse width, and
analyzing second echoes generated responsive to said second transmitted radar pulses to determine a revised level measurement for said material in said tank.

2. The method of claim 1, wherein said first scan distance is across at least a majority of a length of said probe (probe length).

3. The method of claim 1, wherein said second pulse width is less than or equal to (≦) ½ said first pulse width.

4. The method of claim 1, further comprising third level scanning performed with third transmitted radar pulses launched by said probe into said tank with a revised measurement window including said approximate level that is less than (<) said first measurement window, wherein said third transmitted radar pulses have a third pulse width that is less than (<) said second pulse width.

5. The method of claim 2, wherein said probe length is at least 20 m, wherein said probe is in contact with said material, and wherein said method comprises guided wave radar (GWR).

6. The method of claim 1, wherein said first pulse width and said second pulse width are set by a control voltage applied to a variable pulse width generator (VPGen) block that includes pulse width setting circuitry.

7. The method of claim 1, further comprising accumulating power from an external power source on a power accumulator between respective ones of said first and said second transmitted radar pulses during said first level scanning and during said second level scanning.

8. A computer program product, comprising:
a memory comprising a non-transitory data storage medium that includes stored program instructions for a resolution mode switching algorithm and a level finding algorithm executable by a processor to enable said processor to execute a method of pulsed radar level sensing for level finding having two or more resolution modes (RMs), said computer program product including:
code for first level scanning performed with first transmitted radar pulses launched by a probe into a tank having at least one material therein, wherein said first transmitted radar pulses have a first pulse width and wherein said first level scanning is over a first scan distance;
code for analyzing first echoes generated responsive to said first transmitted radar pulses to determine at least one approximate level for said material in said tank;
code for second level scanning performed with second transmitted radar pulses launched by said probe into said tank with a first measurement window including said approximate level that is less than (<) said first scan distance, said second transmitted radar pulses having a second pulse width that is less than (<) said first pulse width, and
code for analyzing second echoes generated responsive to said second transmitted radar pulses to determine a revised level measurement for said material in said tank.

9. The computer program product of claim 8, wherein said first scan distance is across at least a majority of a length of said probe (probe length).

10. The computer program product of claim 8, wherein said second pulse width is less than or equal to (≦) ½ said first pulse width.

11. The computer program product of claim 8, further comprising code for third level scanning performed with third transmitted radar pulses launched by said probe into said tank with a revised measurement window including said approximate level that is less than (<) said first measurement window, wherein said third transmitted radar pulses have a third pulse width that is less than (<) said second pulse width.

12. A pulsed radar level gauge system, comprising:
a processor having an associated memory storing a resolution mode switching algorithm and a level finding algorithm;
a variable pulse width generator (VPGen) block that includes pulse width setting circuitry coupled to receive control signals originating from said processor;
a transceiver for coupling to a probe in a tank having at least one material therein including an input coupled to an output of said VPGen block for transmitting radar pulses and an output coupled through a sensor to an input of said processor for processing echo signals received responsive to said radar pulses;
said resolution mode switching algorithm when implemented by said processor causing:
controlling said VPGen block to cause first transmitted radar pulses launched by said probe into said tank to provide first level scanning, said first transmitted radar pulses having a first pulse width and wherein said first level scanning is over a first scan distance;
controlling said VPGen block to cause second transmitted radar pulses launched by said probe into said tank to provide second level scanning with a measurement window that is less than (<) said first scan distance, said second transmitted radar pulses having a second pulse width that is less than (<) said first pulse width;
wherein said level finding algorithm analyzes first echoes generated responsive to said first transmitted radar pulses to determine an approximate level, and analyzes second echoes generated responsive to said second transmitted radar pulses to determine a revised level measurement for said material in said tank.

13. The system of claim 12, wherein said first scan distance is across at least a majority of a length of said probe (probe length).

14. The system of claim 12, wherein said second pulse width is less than or equal to (≦) ½ said first pulse width.

15. The system of claim 12, further comprising a power accumulator for accumulating power supplied by an external power source between respective ones of said ones of said first and said second transmitted radar pulses during said first level scanning and during said second level scanning.
